(19) United States
(12) Patent Application Publication
(10) Pub. No.: US 2005/0032559 A1
(43) Pub. Date: Feb. 10, 2005

(54) Hinge device and cellular phone using the same

(76) Inventors: Hiroshi Sudo, Tokyo (JP); Minoru Hayashi, Iida-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/492,299

(22) PCT Filed: Oct. 11, 2002
(86) PCT No.: PCT/JP02/10626

(30) Foreign Application Priority Data
Oct. 15, 2001 (JP) 2001-317224

(51) Int. Cl. H04M 1/00

(52) U.S. Cl. 455/575.3

(57) ABSTRACT

An object of this invention is to provide a hinge device excellent in durability and a foldable cellular phone using the hinge device.

The hinge device includes: a cylindrical case 7 having a bottom formed on one end; a disk member 6 contained in the bottom of this case, and rotating integrally with this case; a cam member 4 contained in the case, wherein at a closed position and an open position of a cover body 12, an engagement state in which the cam member is engaged with the disk member is maintained to fixed the cover body 12, and the engagement state is cancelled by rotation caused by an opening or a closing operation of the cover body 12; an urging means 3 for causing one end to press the cam member in a direction of the disk member, and for maintaining the engagement state in which the cam member is engaged with the disk member; and a stop 2 that prevents the other end of the urging means from moving in an axial direction, and that rotates integrally with the cam member.

### TECHNICAL FIELD

The present invention relates to a hinge device and a foldable cellular phone using the hinge device.

### BACKGROUND ART

In recent years, a foldable cellular phone which has a sufficiently secured space as an operation portion or a display portion while it is used, and which folds and is convenient to carry when it is not used has spread as portable equipment. The foldable cellular phone is constituted so that a main body serving as a transmitter portion and a cover body serving as a receiver portion are connected with each other by a hinge device to be freely opened and closed.

As a hinge device used between a main body A and a cover (cover body) B of a cellular phone, a hinge device shown in, for example, FIG. 16 is disclosed (Japanese Patent Application Laid-Open No. 2001-1527286). This hinge device 80 includes one hinge member 81 and the other hinge member 83 rotatably connected to the hinge member 81 through a connection shaft 82.

The hinge member 81 is cylindrical, a rotational shaft body of the connection shaft 82 is rotatably inserted into the hinge member 81, a tip end of the rotational shaft body penetrates the hinge member 81, and the other hinge member 83 is fitted into and fixed to the tip end thereof. A movable member 83 is arranged in the hinge member 81, and a guide portion is formed on each side of this movable member 84.

The other hinge device 83 is comprised of a contact member 85 on a hinge member 81-side and a support member 86 on an opposite side to the hinge member 81-side. The movable member 84 is urged toward the contact member 85 by a coil spring 87, a pair of pressing protrusions 88 are formed on an end surface of the movable member 84 opposed to the contact member 85, and a cam mechanism is formed by the movable member 84 and the contact ember 85. This enables rotation between the one hinge member 81 and the other hinge member 83, thereby constituting a hinge mechanism that rotatably connects the main body A with the cover B.

In the hinge device, the movable member 84 and the contact member 85, i.e., the hinge device 81 and the other hinge device 83 slidably move as the cam mechanism, and make relative rotational motions. Normally, a lubricant is filled therebetween to ensure smooth rotation.

However, the hinge device 81 and the other hinge device 83 are arranged while being exposed to the outside, and tend to be influenced by a utilization environment of the portable equipment, and a dust and the like tend to adhere to the hinge device 81 and the other hinge device 83. Due to this, an amount of the dust increases with the passage of time, with the result that a smoothness of the cam mechanism is disadvantageously lost and that durability is disadvantageously deteriorated.

The present invention has been achieved in light of these disadvantages, and it is an object of the present invention to provide a hinge device excellent in durability and a cellular phone using the hinge device.

### DISCLOSURE OF THE INVENTION

In order to solve the technical disadvantages, as shown in FIG. 1 or 10, the present invention provides a hinge device rotatably connecting a main body 13 with a cover body 12, constituted to comprise: a cylindrical case 7, 66 having a bottom formed on one end; a disk member 6, 65 contained in the bottom of the case, and rotating integrally with the case; a cam member 4, 64 contained in the case, wherein at a closed position and an open position of the cover body 12, an engagement state in which the cam member is engaged with the disk member is maintained to fixed the cover body 12, and the engagement state is cancelled by rotation caused by an opening or a closing operation of the cover body 12; urging means 3, 63 for causing one end to press the cam member in a direction of the disk member, and for maintaining the engagement state in which the cam member is engaged with the disk member; and a stop 2, 62 that prevents the other end of the urging means from moving in an axial direction, and that rotates integrally with the cam member.

Further, as shown in FIG. 1, the hinge device according to the present invention is constituted so that a part of a spherical body 5 is rotatably contained and held by the disk member 6, and a pair of recesses 38 having smooth wall surfaces formed thereon are provided in the cam member 4, the spherical body 5 escapes from the recesses 38 against the urging means 3, following rotation caused by opening or closing and moving of the cover body, and at the open position and the closed position of the cover body 12, the spherical body 5 is engaged with the recesses 38 and the cover body 12 is thereby fixed.

Furthermore, as shown in FIG. 10, the hinge device according to the present invention is constituted so that a recessed portion having a smooth wall surface formed thereon or a projected portion is provided in the disk member 65, and the projected portion or the recessed portion having the smooth wall surface formed thereon is provided in the cam member 64, thereby constituting a recess-projection engagement structure, the projected portion escapes from the recessed portion against the urging means 63, following rotation caused by opening or closing and moving of the cover body 12, and at the open position and the closed position of the cover body 12, the projected portion is engaged with the recessed portion and the cover body 12 is thereby fixed.

Moreover, the hinge device according to the present invention is constituted to comprise a shaft body 8, 67 rotatable integrally with the cam member and the stop, a part of a shaft of the shaft body being rotatably inserted into holes provided in a central portion of the bottom of the case 7, 66 and a central portion of the disk member 6, 65, respectively, and an other part of the shaft being fitted into fitting holes provided in a central portion of the cam member 4, 64 and a central portion of the stop 2, 62, respectively.

Additionally, the hinge device according to the present invention is constituted to comprise a hook 1, 61 rotating integrally with the stop 2, 62, and including a plurality of stopper claws, the hook 1, 61 provided on a side portion of the stop and on an end of the shaft body 8, 67.

A cellular phone according to the present invention is constituted so that the case 7, 66 is fixed to one of the main body 13 including a transmitter portion and the like and the cover body 12 including a receiver portion and the like, and so that the main body 13 is rotatably connected to the cover body 12 using any one of the above-stated hinge devices for stopping the hook 1, 61 on the other one of the main body 13 and the cover body 12.

### BRIEF DESCRIPTION OF THE DRAWINGS

FIG. 1 is an exploded perspective view of a hinge device according to a first embodiment of the present invention;

FIG. 2 depicts an outside of the hinge device according to the first embodiment, in which FIG. 2(a) is a front view and FIG. 2(b) is a right side view;

FIG. 3 is a schematic diagram of a cellular phone using the hinge device according to the embodiment;

FIG. 4(a) is a front view, FIG. 4(b) is a right side view, FIG. 4(c) is a left side view, and FIG. 4(d) is a cross-sectional view taken along a line A-A of a hook of the hinge device;

FIG. 5(a) is a front view, FIG. 5(b) is a left side view, FIG. 5(c) is a right side view, FIG. 5(d) is a cross-sectional view taken along a line B-B, FIG. 5(e) is a cross-sectional view taken along a line C-C, FIG. 5(f) is a cross-sectional view taken along a line D-D of a cam member of the hinge device;

FIG. 6(a) is a right side view, FIG. 6(b) is a front view, FIG. 6(c) is a left side view, and FIG. 6(d) is a cross-sectional view taken along a line E-E of a disk member of the hinge device;

FIG. 7(a) is a front view, FIG. 7(b) is a right side view, and FIG. 7(c) is a cross-sectional view taken along a line F-F of a case of the hinge device;

FIG. 8(a) is a front view, FIG. 8(b) is a cross-sectional view taken along a line G-G, FIG. 8(c) is a plan view, and FIG. 8(d) is a right side view of a shaft body of the hinge device;

FIG. 9 depicts a cross section of the hinge device according to the first embodiment;

FIG. 10 is an exploded perspective view of a hinge device according to a second embodiment of the present invention;

FIG. 11 depicts an outside of the hinge device according to the second embodiment, in which FIG. 11(a) is a front view, and FIG. 11(b) is a right side view;

FIG. 12(a) is a front view, FIG. 12(b) is a left side view, FIG. 12(c) is a right side view, FIG. 12(d) is a cross-sectional view taken along a line H-H, and FIG. 12(e) is a cross-sectional view taken along a line I-I of a cam member of the hinge device;

FIG. 13(a) is a right side view, FIG. 13(b) is a cross-sectional view taken along a line J-J, and FIG. 13(c) is a cross-sectional view taken along a line K-K of a disk member of the hinge device;

FIG. 14(a) is a left side view, FIG. 14(b) is a right side view, and FIG. 14(c) is a cross-sectional view taken along a line L-L of a case of the hinge device; and

FIG. 15 depicts a cross section of a hinge device according to the second embodiment; and FIG. 16(a) is a front view, and FIG. 16(b) is a cross-sectional view of a conventional hinge device.

### BEST MODE FOR CARRYING OUT THE INVENTION

Embodiments of the present invention will be described hereinafter based on the drawings.

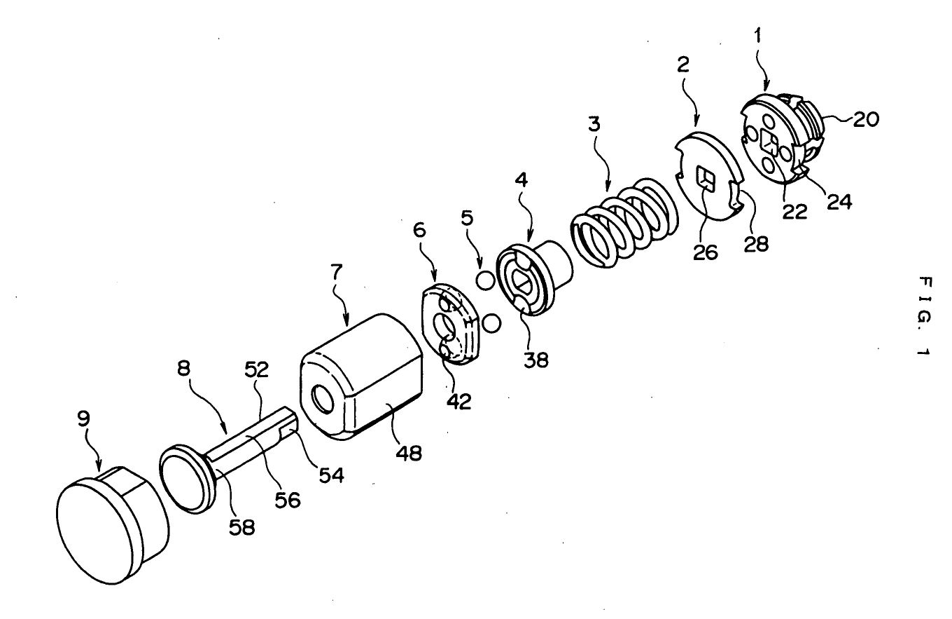

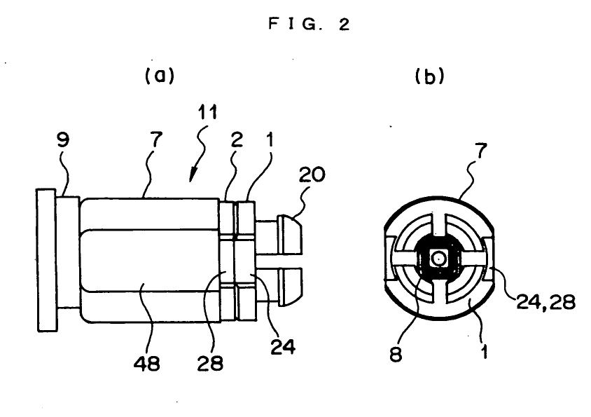

FIG. 1 is an exploded perspective view of a hinge device 11 employed in a portable equipment such as a foldable cellular phone. An outside of this hinge device 11 is comprised of a hook 1, a stop 2, a case 7, and a cover 9 as shown in FIG. 2, whereas the other members are contained inside of the case 7.

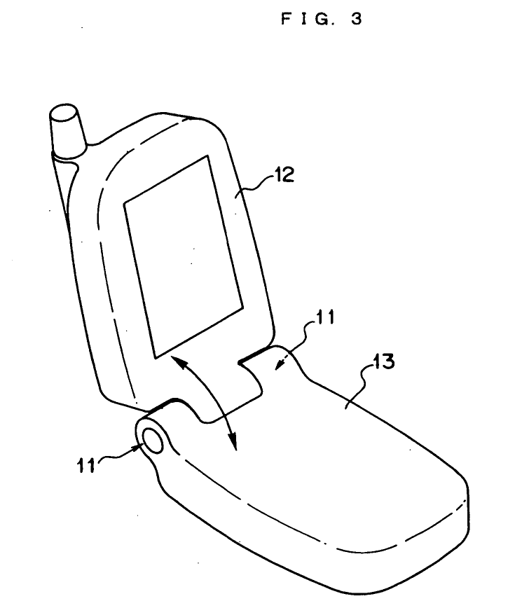

As shown in FIG. 3, the foldable cellular phone includes a cover body 12 comprised of a receiver portion provided with a display screen or the like, and a main body 13 comprised of a transmitter portion provided with an operation key or the like. The stop of the hinge device 11 is stopped in a cylindrical portion provided in the cover body 12, and the case 7 of the hinge device 11 is fixedly fitted into a cylindrical portion provided in the main body 13, whereby the main body 13 and the cover body 12 are connected with each other so as to be freely opened and closed.

The hinge device 11 includes, as constituent elements, the hook 1, the stop 2, a coil spring 3, a cam member 4, two spherical bodies 5, a disk member 6, the case 7, a shaft body 8, and the cover 9. Among these constituent elements, the cam member 4, the spherical bodies 5, and the disk member 6 mainly constitute a cam mechanism.

The hook 1 and the cover 9 are each made of synthetic resin such as ABS, the shaft body 8 is made of made of metal such as aluminum or a steel product, and the coil spring 3 is made of a steel product. The stop 2, the cam member 4, the spherical bodies 5, the disk member 6, and the case 7 are each made of metal such as a steel product or stainless steel. The stop 2, the cam member 4, the disk member 6, the case 7, and the shaft body 8 are preferably subjected to a surface treatment such as electroless Ni plating or Ni plating.

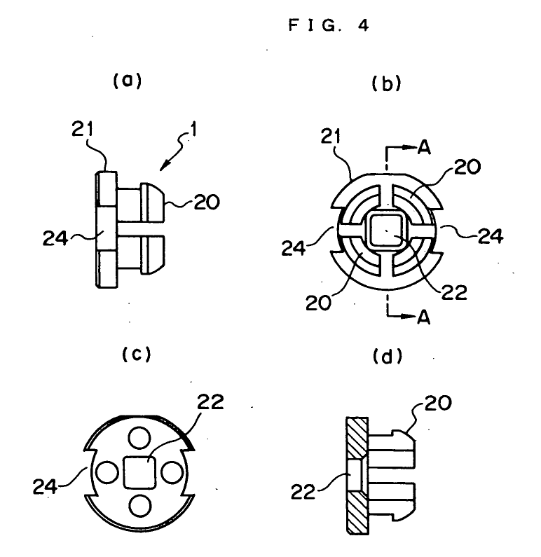

The respective constituent elements will be described. As shown in FIG. 4, the hook 1 has four stop claws 20 formed outward of a substrate 21, and a rectangular hole 22 is formed in a central portion of the substrate 21. The hook 1 has also fitting grooves 24 in left and right regions on an outer surface of the substrate 21, respectively. As shown in FIG. 1, the stop 2 has a rectangular hole 26 provided in a central portion of a disk-like base, and fitting grooves 28 provided in left and right regions of the base, respectively. The coil spring 3 is a compression spring, and urges the cam member 4.

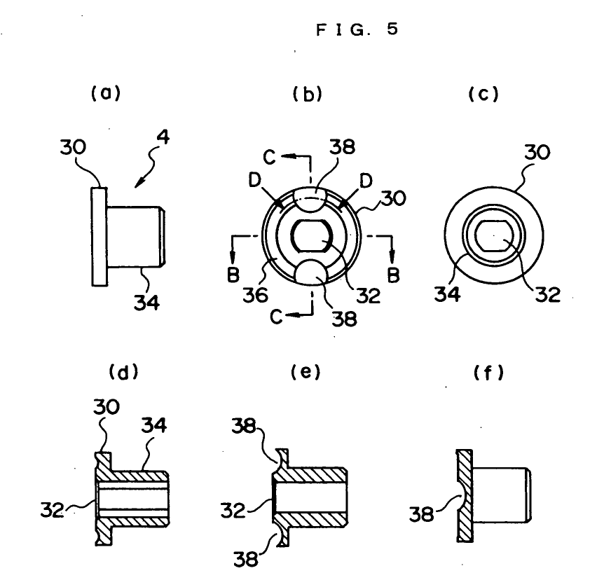

As shown in FIG. 5, the cam member 4 is a member in which a shaft 34 provided with a through hole 32 is formed to protrude from a central portion of a hollow disk portion 30. This through hole 32 is formed to be continuous and equal in shape to the disk portion 30, and is an elliptic hole having upper and lower portions in parallel and circular arc-like left and right portions. An annular shallow groove-like guide path 36 is formed on an outer surface of the disk portion 30, and recessed portions 38 are formed in upper and lower regions of this guide path 36, respectively. Each of the recessed portions 38 is a shallow spherical hole that forms a part of a sphere, and has radii set so that a radius in a cross section taken along a line D-D is larger than that in a cross section taken along a line C-C. The spherical bodies 5 enter spherical wall surfaces of the respective recessed portions 38, whereby moving velocities of the spherical bodies 5 are urged.

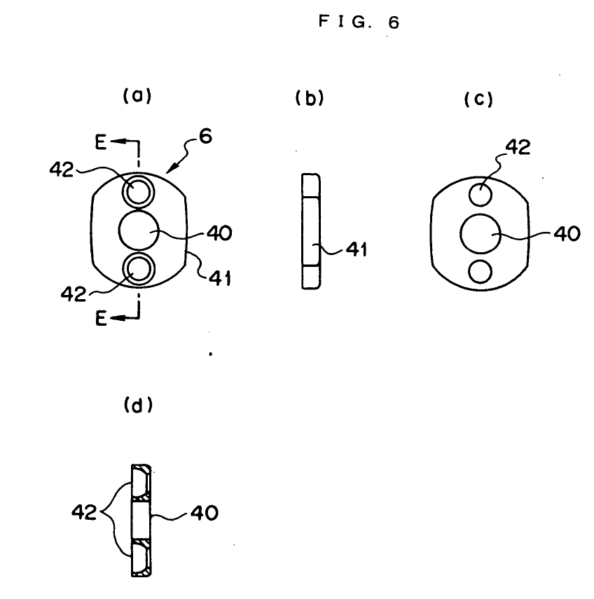

FIG. 6 depicts the disk member 6. An outside of this disk member 6 is an elliptic plate having flat portions 41 that are parallel regions formed left and right, respectively, and a circular hole 40 formed in a central portion. On one of surfaces of the disk member 6, semispherical deep hole portions 42 are formed in upper and lower regions on the same circumference, respectively. The spherical bodies 5 are rotatably held in the respective hole portions 42 while substantially half or more of each spherical body 5 is contained in the hole portion 42.

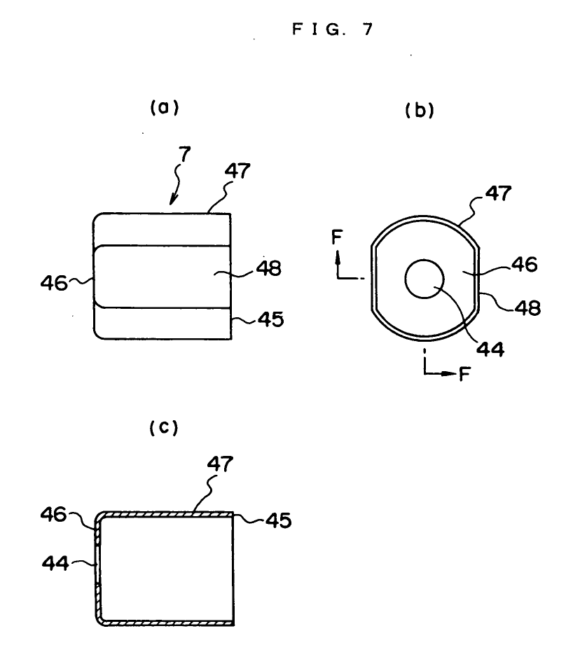

As shown in FIG. 7, the case 7 is a cylindrical container that has a bottom 46, which has a through hole 44 provided in a central portion, formed on one end, and that has an opening 45 formed on the other end. The cylindrical portion 45 of the case 7 has left and right wall surfaces parallel to each other and circular arc-like upper and lower portions each having an elliptic cross section. The parallel wall surfaces are fitted, as fitting portions 48, into respective cylindrical portions provided on the main body 13 of the cellular phone. The disk member 6, the spherical bodies 5, the cam member 4, and the coil spring 3 are contained in this case 7.

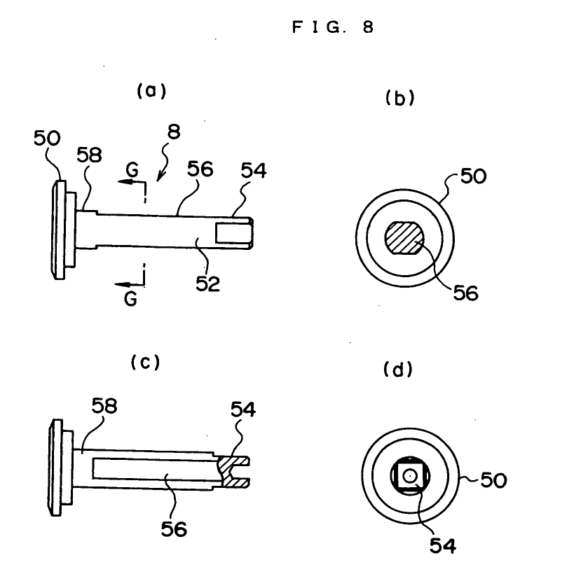

As shown in FIG. 8, the shaft body 8 is comprised of a disk-like head 50 and a shaft 52. This shaft 52 has a rectangular shaft 54 having a rectangular cross section formed in a tip end, a region 56 having an elliptic cross section formed in an intermediate portion, and a columnar portion 58 having a circular cross section formed in region near the head 50 of the shaft body 52.

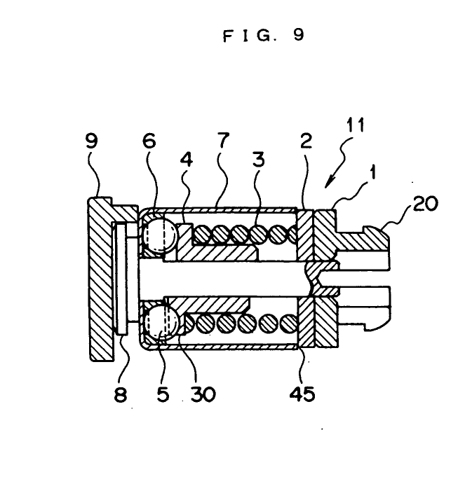

As shown in FIG. 9, in the hinge device 11, the disk member 6, into which the spherical bodies 5 are fitted, the cam member 4, and the coil spring 3 are contained in the case 7 in a depth direction in this order. The coil spring 3 is fitted into an outer periphery of the shaft body 34 of the cam member 4, one end of this coil spring 3 is brought into contact with the disk portion 30 of the cam member 4, the other end of the coil spring 3 is brought into contact with the stop 2, and this stop 2 is arranged outside of the opening 45 of the case 7.

The shaft 52 of the shaft body 8 is inserted into the case 7 from the through hole 44 at the bottom 46 of the case 7, the hook 1 is fitted into the tip end of the shaft body 52, and a tip end of the shaft 52 protruding from the hook 1 is finally crimped. The hinge device is thus assembled.

In this state, the disk member 6, the spherical bodies 5, the cam member 4, and the coil spring 3 are contained in the case 7, whereas the opening 45 of the case 7 is closed by the stop 2. At this time, the elliptic through hole 32 of the cam member 4 is fitted into the elliptic region 56 of the shaft 8, and the rectangular hole 26 of the stop 2 and the rectangular hole 22 of the hook 1 are both fitted into the rectangular shaft 54 of the shaft body 8.

As a result, the cam member 4, the stop 2, and the hook 1 rotate integrally with the shaft body 8. If the cam member 4 rotates, the shaft body 8 rotates and the stop 2 and the hook 1 rotate, accordingly. The through hole 44 of the case 7 and the hole 40 of the disk member 6 penetrate the cylindrical portion 58 of the shaft body 8. Due to this, the case 7 and the disk member 6 are free relative to rotation of the shaft body 8, and the disk member 6 is fitted into the case 7, so that the disk member 6 and the case 7 rotate integrally with each other.

Further, the cam member 4 is constantly urged by the coil spring 3 in a direction of the disk member 6, and a cam mechanism is formed through the spherical bodies 5 by the cam member 4 and the disk member 6. Therefore, this hinge device constitutes a hinge mechanism, through the cam mechanism, in which the stop 2 and the hook 1 rotate relative to the case 7.

To attach this hinge device to the cellular phone shown in FIG. 3, the stop claws 20 of the hook 1 in the hinge device 11 are stopped by hinge attachment holes provided in the cover body 12 of the cellular phone, respectively, and the stop 2 is fixedly fitted. Further, the fitting portions 48 of the case 7 in the hinge device are fixedly fitted into hinge attachment cylindrical portions provided in the main body 13, respectively.

If the cover body 12 of the cellular phone to which the hinge device is attached is manually opened, the cam mechanism operates. At the time of opening the cover body 12, the cam member 4 rotates together with the stop 2 (hook 1), the recessed portion 38 of the cam member 4 is disengaged from one of the spherical bodies 5 held in the disk member 6, the spherical body 5 rolls on the guide path 36 of the cam member 4 simultaneously with the rotation of the cam member 4, and the recessed portions 38 move in a direction f the other spherical body 5. When the expansion of the cover body 12 is finished, the recessed portion 38 is engaged with the other spherical body 5.

A cam operation between the disk member 6 and the cam member 4 is carried out deep in the case 7. By filling a lubricant into portions of this cam mechanism, the operation of the cam mechanism is carried out more smoothly. Further, at the time of engagement, an impetus is applied to entry of the spherical bodies 5 into the recessed portion 38 by an urging force of the coil spring 3, thereby giving a sense of clicking. This sense of clicking is given when the rotation of the cover body 12 is finished, and a sense of modulation is thereby given to the opening and closing operations of the cover body 12.

When the cover body 12 is closed, the cam member 4 rotates simultaneously with closing and moving of the cover body 12, and the recessed portion 38 is disengaged from the other spherical body 5 and moves in a direction of the original spherical body 5. When the recessed portion 38 is engaged with the original spherical body 5, an impetus is intensified similarly to the opening of the cover body 12, and the cover body 12 is closed with the sense of clicking given. If a clearance is provided between the case 7 and the disk member 6 so that the disk member 6 is freely fitted into the case 7, then a cam member sound is produced when opening or closing the cover body 12 and the sense of modulation is further given to the opening and closing of the cover body 12.

As can be seen, according to the cellular phone using the hinge device 11 according to the first embodiment, the cam member and the disk member that serve as the cam mechanism are arranged deep in the case. Therefore, entry of a dust is prevented, the smooth operation of the cam mechanism is maintained, and the durability of the cam mechanism is enhanced. Further, since the cam mechanism is contained in the case 7, the lubricant filled into the cam mechanism is held in a favorable state and leakage of the lubricant is prevented. This can therefore prevent the cellular phone from being made dirty. Besides, since the cellular phone is free from an influence of the dust, a good sense of clicking is maintained for a long period of time during opening and closing of the cover body 12.

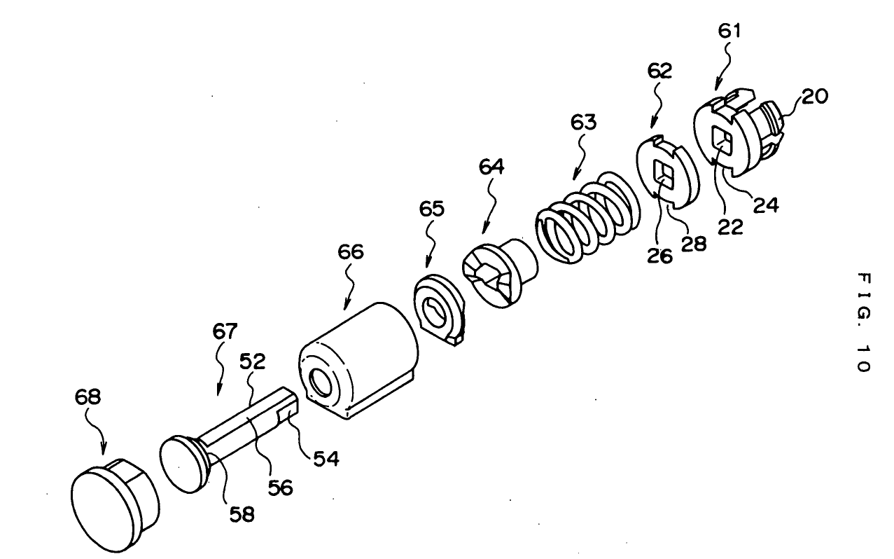

FIG. 10 depicts a hinge device according to a second embodiment. This hinge device 15 is, similarly to the hinge device 11 according to the first embodiment, used in the portable equipment such as the foldable cellular phone shown in FIG. 3. This hinge device 15 differs from the hinge device 11 in that since the hinge device 15 is small in size, a cam mechanism which does not use the spherical bodies 5 as used in the hinge device 11 is constituted.

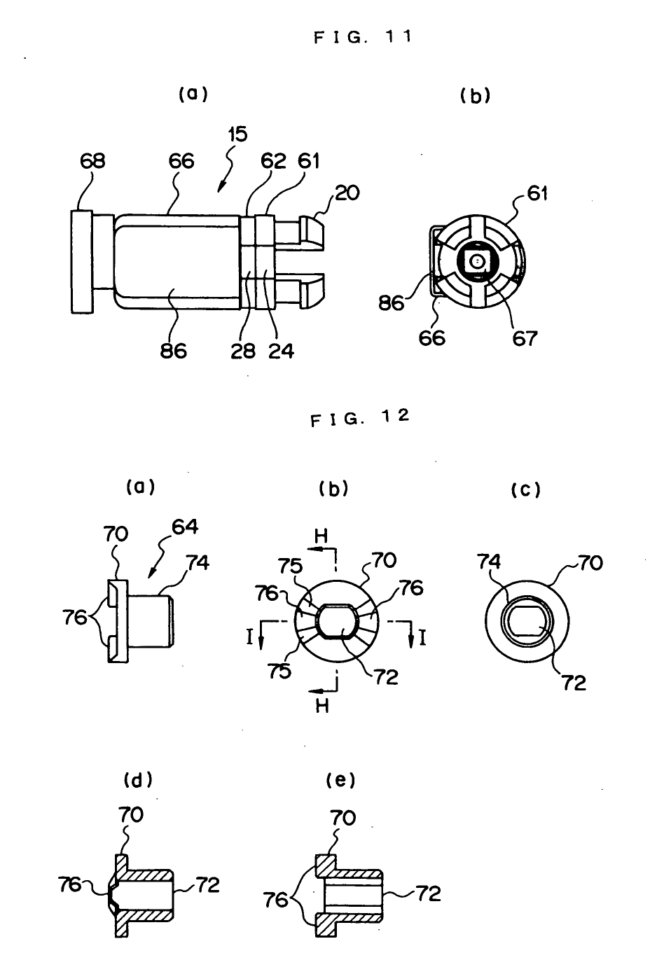

As shown in FIG. 11, an outside of the hinge device 15 is comprised of a hook 61, a stop 62, a case 66, and a cover 68, whereas the remaining members are contained in the case 66 similarly to the hinge device 11. This hinge device 15 includes, as constituent elements, the hook 61, the stop 62, a coil spring 63, a cam member 64, a disk member 65, the case 66, a shaft body 67, and the cover 68. Among these constituent elements, the cam member 64 and the disk member 65 mainly constitute the cam mechanism.

Among the constituent elements of this hinge device 15, the hook 61, the stop 62, the coil spring 63, and the shaft body 67 are equal in basic structure to the hook 1, the stop 2, the coil spring 3, and the shaft body 8 according to the hinge device 11, respectively, which will not be, therefore, described in the second embodiment.

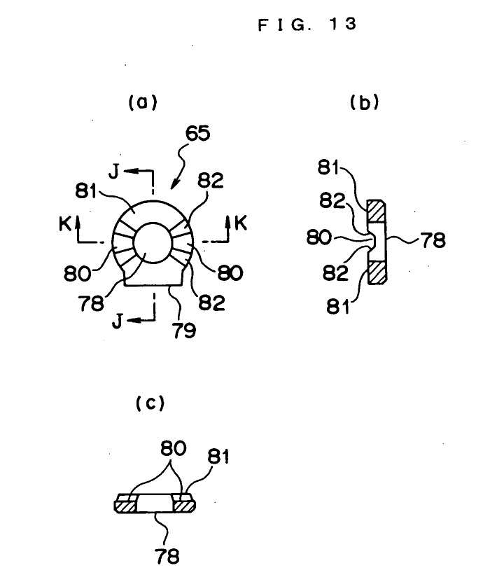

As shown in FIG. 12, the cam member 64 is a member in which a shaft 75 provided with a through hole 72 is formed to protrude from a central portion of a hollow disk member 70. This through hole 72 is formed to be continuous and equal in shape to the disk portion 70, and is an elliptic hole having upper and lower portions in parallel and circular arc-like left and right portions. Engagement projected portions 76 are formed in left and right regions of the disk portion 70, respectively, between which regions the through hole 72 is put. Each of the engagement projected portions 76 is a trapezoidal projected portion having left and right side surfaces 75 inclined, having a ridgeline formed in a direction of a center of the disk portion 70, and having an upper surface reduced toward the center thereof.

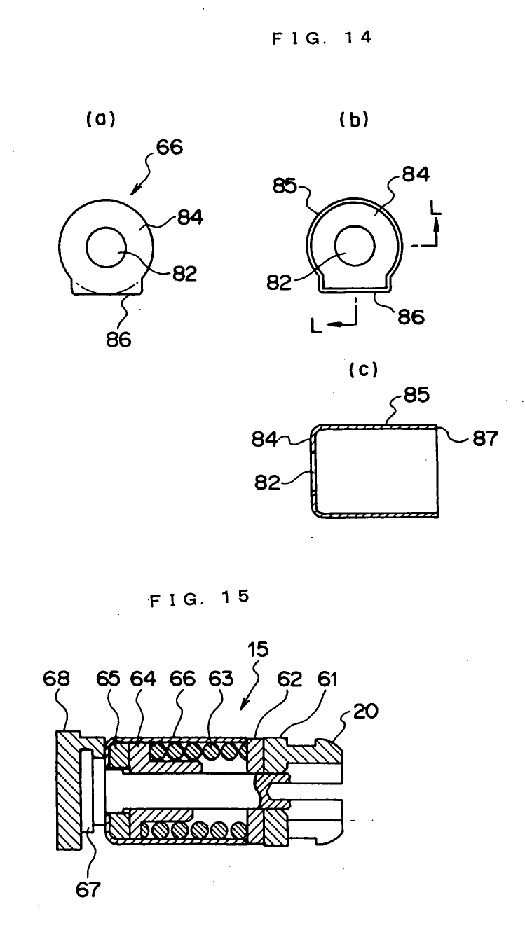

FIG. 13 depicts the disk member 65. The disk member 65 is a plate having a circular hole 78 formed in a central portion and having an outward protrusion 79 formed on part of a periphery. Engagement recessed portions 80 are formed in left and right regions of the disk member 65, respectively, between which regions the hole 78 is put. Both side surfaces of each of these engagement recessed portions 80 have guide path 81 arranged annularly inclined conically, respectively. The engagement projected portions 76 of the cam member 64 are fitted into and engaged with the respective engagement recessed portions 80 of this disk member 65.

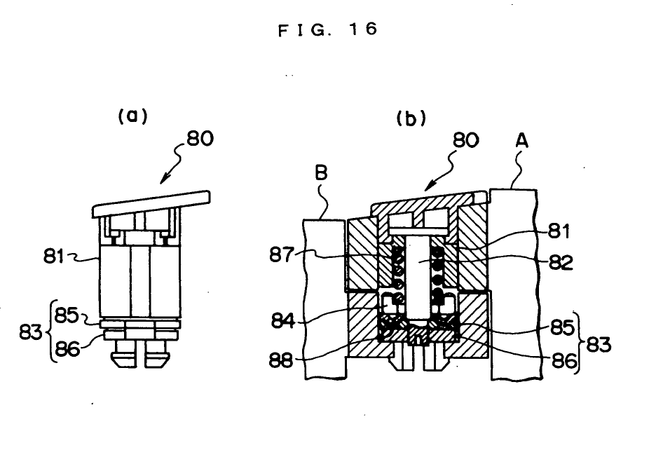

As shown in FIG. 14, the case 66 is a cylindrical container having a bottom 84, which is provided with a through hole 82 in a central portion, formed on one end, and an opening 87 formed on the other end. A cylindrical portion 85 of the case 66 is shaped so that an outward protrusion 86 is formed partially. This protrusion 86 has a flat cylindrical surface, which is fitted into a cylindrical portion provided in the main body 13 of the cellular phone. The disk member 65, the cam member 64, and the coil spring 63 are contained in this case 66.

As shown in FIG. 15, in the hinge device 15, the disk member 65 and the cam member 64 are contained in the case 66 in a depth direction in this order. The coil spring 63 is fitted into an outer periphery of the shaft body 74 of the cam member 64, and one end of this coil spring 63 is brought into contact with the disk portion 70 of the cam member 64. The other end of the coil spring 63 is brought into contact with the stop 62, and this stop 62 is arranged outside of the opening 87 of the case 66.

The shaft 52 of the shaft body 67 is inserted into the case 66 from the through hole 82 at the bottom 84 of the case 66, the disk member 65, the cam member 64, the coil spring 63, and the stop 62 are inserted into the case 66, the hook 61 is fitted into a tip end of the shaft 52, and the tip end of the shaft 52 protruding from the hook 61 is finally crimped. The hinge device is thus assembled.

In this state, the disk member 65, the cam member 64, and the coil spring 63 are contained in the case 66, whereas the opening 87 of the case 66 is closed by the stop 62. At this time, the elliptic through hole 72 of the cam member 64 is fitted into the elliptic region 56 of the shaft 67, and the rectangular hole 26 of the stop 62 and the rectangular hole 22 of the hook 61 are both fitted into the rectangular shaft 54 of the shaft body 67.

As a result, the cam member 64, the stop 62, and the hook 61 rotate integrally with the shaft body 67. If the cam member 64 rotates, the shaft body 67 rotates and the stop 62 and the hook 61 rotate, accordingly. The through hole 64 of the case 66 and the hole 78 of the disk member 65 penetrate the cylindrical portion 58 of the shaft body 67. Due to this, the case 66 and the disk member 64 are free relative to rotation of the shaft body 67, and the disk member 66 is fitted into the case 66, so that the disk member 64 and the case 66 rotate integrally with each other.

Further, the cam member 63 is constantly urged by the coil spring 63 in a direction of the disk member 64, and a cam mechanism is formed by the cam member 64 and the disk member 64. Therefore, this hinge device constitutes a hinge mechanism, through the cam mechanism, in which the stop 62 and the hook 61 rotate relative to the case 66. This hinge device is used while being attached to the cellular phone shown in FIG. 3 or the like similarly to the hinge device 11.

If the cover body 12 of the cellular phone to which the hinge device is attached is manually opened, the cam mechanism operates. At the time of opening the cover body 12, the cam mechanism 64 rotates together with the stop 62 (hook 61), the engagement projected portion 76 of the cam member 64 is disengaged from one of the engagement recessed portion 80 of the disk member 65, the engagement projected portion 76 slidably moves on a guide path 81 of the disk member 65, and moves toward the other engagement recessed portion 80. When the expansion of the cover body 12 is finished, the projected portion 76 of the cam member 64 is engaged with the other engagement recessed portion 80.

Such a cam operation between the disk member 65 and the cam member 64 is carried out deep in the case 66. By filling a lubricant into portions of this cam mechanism, the operation of the cam mechanism is carried out more smoothly. Further, at the time of engagement, an urging force of the coil spring 63 allows the engagement projected portions 76 of the cam member 64 to slip off from the tapered surfaces 82 of the engagement recessed portions 80. An impetus is applied to the slip, whereby a sense of clicking is given. This sense of clicking is given when the rotation of the cover body 12 is finished, thereby giving a sense of modulation to opening and closing of the cover body 12.

When the cover body 12 is closed, the cam member 64 rotates simultaneously with closing and moving of the cover body 12, and the engagement projected portion 76 is disengaged from the engagement recessed portion 80 of the disk member 65 and moves in a direction of the original engagement recessed portion 80. When the engagement projected portion 76 is engaged with the original engagement recessed portion 80, an impetus is intensified similarly to the opening of the cover body 12, and the cover body 12 is closed with the sense of clicking given. If a clearance is provided between the case 66 and the disk member 65 so that the disk member 66 is freely fitted into the case 7, then a cam member sound is produced when opening or closing the cover body and the sense of modulation is further given to the opening and closing of the cover body 12.

As can be seen, according to the cellular phone using the hinge device 15 according to the second embodiment, the cam member and the disk member that serve as the cam mechanism are arranged deep in the case. Therefore, entry of a dust is prevented, the smooth operation of the cam mechanism is maintained, and the durability of the cam mechanism is enhanced. Further, since the cam mechanism is contained in the case, leakage of the lubricant filled into the cam mechanism is prevented, thereby preventing the cellular phone from being made dirty. Besides, since no dust adheres to the cellular phone, a good sense of clicking is maintained for a long period of time during opening and closing of the cover body 12.

As described so far, the hinge device according to the present invention adopts the constitution of including the disk member contained in the bottom of the case; the cam member an engagement state of which with this disk member is maintained to thereby fix the cover body, and the engagement of which is cancelled by the opening and closing operations; the urging means for maintaining the engagement state; and the stop that prevents movement of this urging means. Therefore, the hinge device exhibits advantages in that the entry of the dust is prevented, the smooth operation of the cam mechanism is maintained, the durability of the cam mechanism is enhanced, and the leakage of the lubricant filled into the cam mechanism is prevented since the cam mechanism is contained in the case, thereby preventing the main body and the cover body from being made dirty.

Further, the hinge device according to the present invention adopts the constitution in which the spherical bodies are contained and held by the disk member, the cam member is provided with recesses, and in which at the open position and the closed position of the cover body, the spherical bodies are fitted into the recesses to thereby fix the cover body. Therefore, the hinge device exhibits an advantage in that the cam mechanism smoothly operates in addition to the advantages stated above.

Moreover, the hinge device according to the present invention adopts the constitution in which the recessed portion or the projected portion is provided in the disk member, the projected portion or the recessed portion is provided in the cam member, thereby constituting the recess-projection engagement structure, and in which at the open position and the closed position of the cover body, the projected portion is engaged with the recessed portion and the cover body is thereby fixed. Therefore, the hinge device exhibits advantages in that the cam mechanism can be constituted to be compact and a reduction in size of the device can be realized in addition to the above-stated advantages.

The cellular phone according to the present invention adopts the constitution of providing the hook rotating integrally with the stop to fix the case to one of the main body and cover body, stopping the hook by the other one of the main body and the cover body, and of rotatably connecting the main body with the cover body. Therefore, the cellular phone exhibits advantages in that the entry of the dust is prevented, the smooth operation of the cam mechanism is maintained, the durability of the cam mechanism is enhanced, and the leakage of the lubricant filled into the cam mechanism is prevented since the cam mechanism is contained in the case, thereby preventing the cellular phone from being made dirty.

1. A hinge device rotatably connecting a main body with a cover body, comprising:
a cylindrical case having a bottom formed on one end;
a disk member contained in the bottom of the case, and rotating integrally with the case;
a cam member contained in the case, wherein at a closed position and an open position of the cover body, an engagement state in which the cam member is engaged with the disk member is maintained to fixed the cover body, and the engagement state is cancelled by rotation caused by an opening or a closing operation of the cover body;
urging means for causing one end to press the cam member in a direction of the disk member, and for maintaining the engagement state in which the cam member is engaged with the disk member; and
a stop that prevents the other end of the urging means from moving in an axial direction, and that rotates integrally with the cam member.

2. The hinge device according to claim 1, wherein
a part of a spherical body is rotatably contained and held by the disk member, and a pair of recesses having smooth wall surfaces formed thereon are provided in the cam member,
the spherical body escapes from the recesses against the urging means, following rotation caused by opening or closing and moving of the cover body, and
at the open position and the closed position of the cover body, the spherical body is engaged with the recesses and the cover body is thereby fixed.

3. The hinge device according to claim 1, wherein
a recessed portion having a smooth wall surface formed thereon or a projected portion is provided in the disk member, and the projected portion or the recessed portion having the smooth wall surface formed thereon is provided in the cam member, thereby constituting a recess-projection engagement structure,
the projected portion escapes from the recessed portion against the urging means, following rotation caused by opening or closing and moving of the cover body, and
at the open position and the closed position of the cover body, the projected portion is engaged with the recessed portion and the cover body is thereby fixed.

4. The hinge device according to any one of claims 1 to 3, comprising:
a shaft body rotatable integrally with the cam member and the stop, a part of a shaft of the shaft body being rotatably inserted into holes provided in a central portion of the bottom of the case and a central portion of the disk member, respectively, and an other part of the shaft being fitted into fitting holes provided in a central portion of the cam member and a central portion of the stop, respectively.

5. The hinge device according to claim 4, comprising:
a hook rotating integrally with the stop, and including a plurality of stopper claws, the hook provided on a side portion of the stop and on an end of the shaft body.

6. A cellular phone, wherein
the case is fixed to one of the main body including a transmitter portion and the like and the cover body including a receiver portion and the like, and
the main body is rotatably connected to the cover body using the hinge device according to claim 5 for stopping the hook on the other one of the main body and the cover body.
